(19) United States
(12) Patent Application Publication
(10) Pub. No.: US 2003/0133206 A1
(43) Pub. Date: Jul. 17, 2003

(54) Fluid containing camera lens filter

(76) Inventor: Brian Belefant, Santa Monica, CA (US)

Correspondence Address: ALBERT O COTA, 5460 WHITE OAK AVE, SUITE A-331, ENCINO, CA, 91316, US

(21) Appl. No.: 10/045,734

(22) Filed: Jan. 15, 2002

(51) Int. Cl. G02B 5/08

(52) U.S. Cl. 359/885; 359/358

(57) ABSTRACT

A fluid-containing lens filter (20) for modifying images in photographic, video and motion picture cameras in the form of a filter housing (22) that consists of a front plate (24), a back plate (26) with a bottom edge (28) and a pair of opposed side edges (30). The edges are juxtaposed between the front plate (24) and the back plate (26), leaving a void therebetween. The bottom edge (28) and side edges (30) are bonded to the front and back forming a fluid-tight chamber (36) within the filter housing. A fluid (38), having light modifying qualities, is disposed within the chamber (36) such that color, translucency, and clarity are altered to create a supplementary visual effect on an image viewed by the camera. Various types of fluids may be used in the filter, affecting the image by means of color pigment (40), particles (42), chemical reactions (48) and myriad different combinations thereof. In addition, particles within the fluids may be illuminated by light sources (54) directed to the edges. Since the fluid-tight chamber may accept any reasonable fluid, the utility has limitless possibilities.

### TECHNICAL FIELD

The present invention pertains to lens filters in general, and more specifically to a lens filter using a fluid medium to create unique visual effects.

### BACKGROUND ART

Previously, many types of lens filters have been used to provide an effective means to alter the visual image that a camera records. In most cases, the prior art has been limited to colored material such as glass or plastic that has had a filter dye added during the manufacturing process. One of the easiest methods of altering the color of a camera's visual image is to place the colored material in front of the camera's lens. In this manner, any image will be tinted with the color of the colored material.

As photography of all kinds (such as still, motion pictures, etc.) has matured, many people consider certain types of photographed images as art, and photography itself as an art form. Obviously, as with many other types of art, the ability of an artist to create new and often times more dramatic images, has been a highly-sought after goal. If there were a way to alter photographic images that would allow a photographer to easily produce a variety of different effects along with an image, it would be a great benefit.

A search of the prior art did not disclose any patents that possess the novelty of the instant invention. However, the following U.S. patents are considered but are not in reality closely related:

| U.S. Pat. No. | Inventor | Issue Date |
|---|---|---|
| 5,862,428 | An | Jan. 19, 1999 |
| 5,624,467 | Texter et al. | Apr. 29, 1997 |
| 5,158,865 | Harder et al. | Oct. 27, 1992 |
| 4,948,717 | Diehl et al. | Aug. 14, 1990 |
| 4,857,446 | Diehl et al. | Aug. 15, 1989 |
| 4,063,266 | Thomas et al. | Dec. 13, 1977 |

An in U.S. Pat. No. 5,862,428 discloses an-apparatus for mounting a lens filter on a camera. A fixing plate rotates and slides within a groove and adjusts horizontally to accommodate the variation of length of the camera lens.

Texter, et al. in U.S. Pat. No. 5,624,467 discloses a process for preparing micro-precipitated dispersions of filter dyes by preparing a concentrated slurry in an aqueous medium of a dye and adding hydroxide to dissolve the dye.

Harder, et al. in U.S. Pat. No. 5,158,865 discloses novel photographic filter dyes that are immobile as incorporated in the filter element but during processing are uniformly converted to a form which is removable from the element. The dye has a structure represented in the formula DYE-LS-BAL.

Diehl, et al. in U.S. Pat. No. 4,948,717 discloses a solid particle dye with dispersions that is used for photographic filter applications which includes a specific formula and relationships.

Diehl, et al in U.S. Pat. No. 4,857,446 discloses a camera dye. The dye is described as having elements in proper proportion and also discloses substitutions that will accomplish the same end result.

Thomas, et al. in U.S. Pat. No. 4,063,266 discloses a filter case that uses two filter retainers with polarized filters positioned parallel to each other. A perforated belt engages sprockets around the retainers permitting them to rotate in unison. Provisions are also included to attach the filter case to the bottom of the camera with a threaded fastener.

### DISCLOSURE OF THE INVENTION

Modern photography has developed into an art form that uses the basic image that is viewed through a camera sees and the addition of ancillary equipment to modify this image to achieve an entirely different picture. One method for accomplishing this modified photograph is by placing, usually, a filter which creates an aberration in shape, changes its achromatic relationship with the true image or modifies its perceived texture. Filters have been used for years to achieve different effects in the color and density of the image in still photography, motion pictures and more recently in video. Therefore, the primary object of the invention is to provide a new and unique photographic filtration system utilizing fluids to modify an image before it is recorded in a camera.

An important object of the invention is that not only the image's color may be changed, which is commonly accomplished with a conventional glass or plastic filter that includes a particular dye, but solid elements may be placed in the fluid such as particles or glitter to create a specialized visual effect.

Another object of the invention is that the particles suspended within the fluid containing filter may be lighted from the side or bottom to create yet another visual effect with unlimited combinations.

Still another object of the invention permits the front and back of the filter to be positioned in an angular relationship with the planes closer on one edge than the other, thus creating an attenuating effect on the perceived image.

Yet another object of the invention is that not only can the invention be configured in a round shape for still photography but can also be made in a square shape which is compatible with standard cinematographic filters, with only a slight modification required in the filter holders to increase the holder's width to accommodate the additional space for the fluid.

And still another object of the invention is that the invention can also be configured to contain gases as well as fluids and solid objects.

A further object of the invention permits a single filter element which allows the fluid to be easily replaced with another fluid without the necessity of purchasing a separate filter, and common fluids may be used to accomplish a myriad of contrasted effects.

A final object of the invention is the versatility of the fluid that may be utilized which includes common color pigment in suspension, particles suspended in a viscous fluid, particles that glitter and reflect light, particles that are buoyant and float or are in random suspension, fluid that changes color with -temperature variations, combined chemicals that cause a dynamic reaction, separate fluids that do not mix and limitless combinations of like choices.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a partial isometric view a typical video camera with the filter in a holder within a matte box attached to the camera.

FIG. 2 is a partial isometric view of the preferred embodiment installed in a filter holder.

FIG. 3 is a partial isometric view of the preferred embodiment with the top open.

FIG. 4 is a left side view of the preferred embodiment.

FIG. 5 is a front elevation view of the preferred embodiment.

FIG. 6 is a right side view of the preferred embodiment.

FIG. 7 is a bottom view of the preferred embodiment.

FIG. 8 is a front elevation view of the preferred embodiment with particles suspended in the fluid.

FIG. 9 is a front elevation view of the preferred embodiment with buoyant particles floating randomly suspended in the fluid.

FIG. 10 is a front elevation view of the preferred embodiment with the fluid containing two chemicals that react dynamically with each other.

FIG. 11 is a front elevation view of the preferred embodiment with two separate fluids that are not miscible with each other.

FIG. 12 is a front elevation view of the preferred embodiment with the top sealed.

FIG. 13 is an exploded front elevation view of the preferred embodiment with a removable top.

FIG. 14 is a partial isometric front elevation view of the preferred embodiment with the front and back plates having a relationship that is wider on one side than on the other which causes the camera viewed image to be attenuated.

FIG. 15 is a partial isometric front elevation view with a light source directed on one side of the filter in its preferred embodiment.

FIG. 16 is a front elevation view of the round filter embodiment.

FIG. 17 is an exploded view of the preferred embodiment.

### BEST MODE FOR CARRYING OUT THE INVENTION

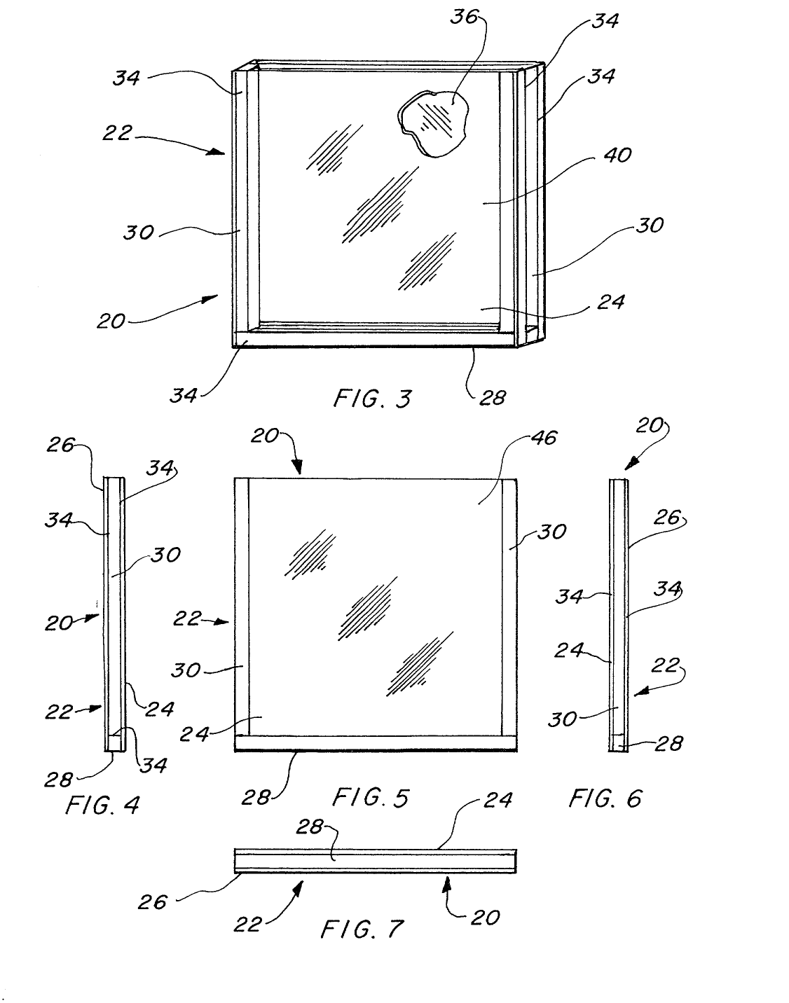

The best mode for carrying out the invention is presented in terms of a preferred embodiment as shown in FIGS. 1 through 17, for a fluid containing lens filter 20 that is used to modify images in still photographic, video and motion picture cameras 18. The lens filter 20 consists of a filter housing 22 having a front plate 24, a back plate 26 with a bottom edge 28, and a pair of opposed side edges 30 juxtaposed between the front plate 24 and back plate 26. This structural relationship forms a void between the front plate 24 and the back plate 26.

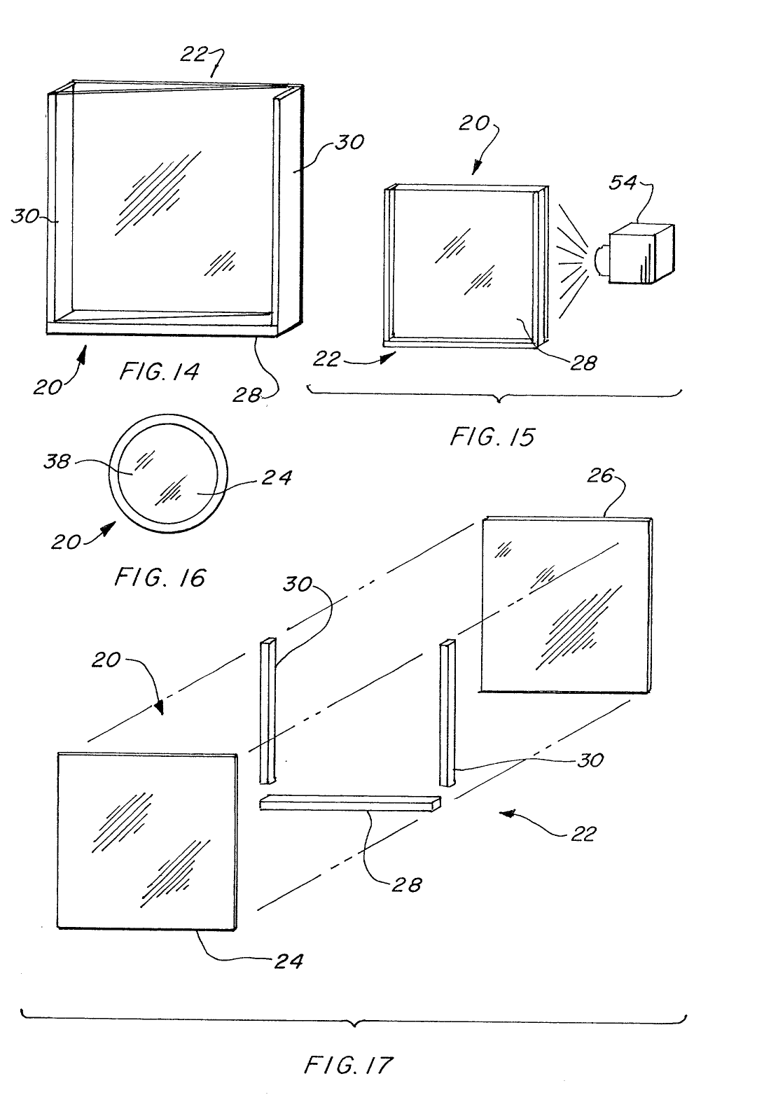

The front plate 24, back plate 26, side edges 30 and bottom edge 28 are formed of glass or optically clear thermoplastic, with the front plate 24 and back plate 26 formed in a preferred round or square shape. The round shape filter 32 is illustrated in FIG. 16 and the balance of the figures depict the square shape. The preferred embodiment of the square shape filter housing 22 has an overall dimension of 6.6 by 6.6 inches square (16.8 by 16.8 cm) and 0.5 inches (1.27 cm) deep, which is a size used by conventional cinematographers in most industry-standard systems. The side edges 30 of the filter housing and the bottom edge 28 are preferably square in shape with the height equal to the width, however in some applications the filter housing can be made in a rectangular configuration.

Another embodiment of the fluid-containing lens filter 20 is shown in FIG. 14, 1 where the front 24 and back plates 26 have a relationship that is wider on one side of the filter than on the other thereby permitting denser filtration on one side which attenuates the image viewed by the camera. The plates 24 and 26 therefore are not parallel as illustrated, although the side edges 30 and bottom edge 28 are sized to accommodate the angular displacement, which allows the filter 20 to have the same edge width to adapt to a filter holder 32 that is common to all of the embodiments of the instant invention that have the square shape.

The bottom edge 28 and said side edges 30 are attached by a bonding process 34 to the front 24 and back 26, thus forming a fluid-tight chamber 36 within the filter housing 22. The type of material or process to accomplish the bonding may be by an adhesive, ultrasonic welding, heat welding which includes elevating the temperature of the edges 28 and 30 of the plates to form a homogeneous mass, or chemically melting the side and bottom edges 28, 30 to the plates into a common mass, when solidified.

In order to alter the visual image modifying qualities of the filter 20, a fluid 38 is disposed within the chamber 36 such that color, translucency, and clarity are altered to create a supplementary visual effect on the image that is viewed by the camera 18.

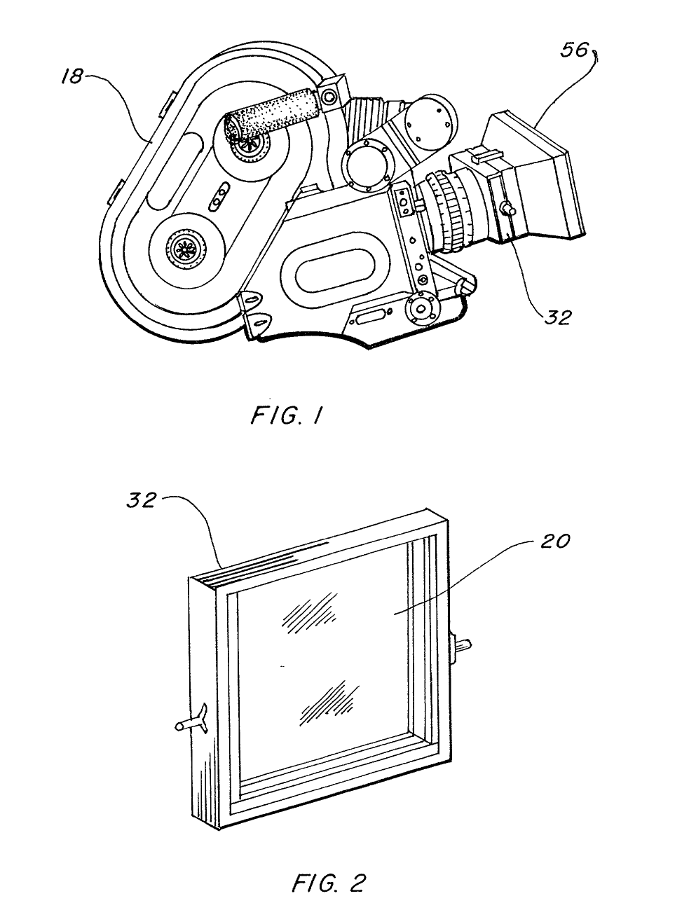

The fluid 38 may include a simple color pigment 40 in suspension, as shown in by itself or combination in FIGS. 2-16. The base fluid may be any acceptable fluid such as water, and the pigment 40 may be a dye or any common additive including brewed coffee, tea, a soft drink, an alcoholic beverage or myriad other fluids which include color.

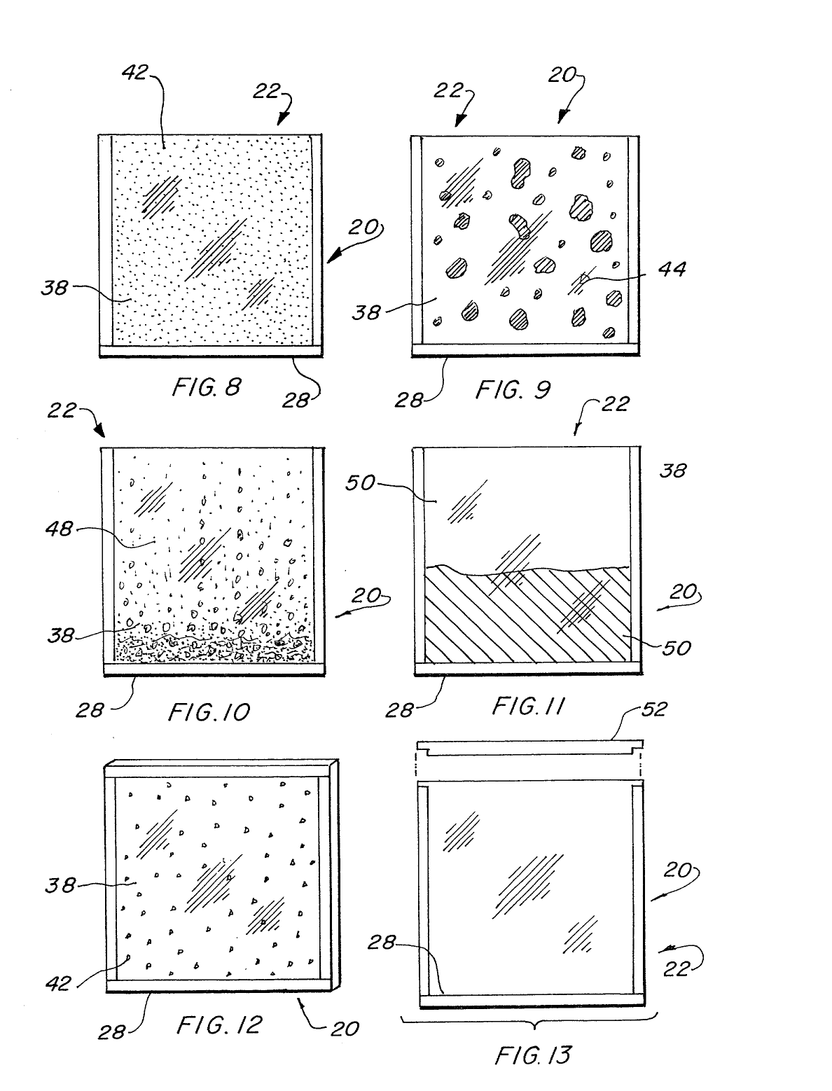

FIG. 8 illustrates a different type of fluid 38, which has sufficient viscosity to suspend a number of particles 42 therein thus adding a perceived texture to the image viewed by the camera 18. The particles 42 may be a glitter means which consists of tiny metallic fragments that reflect light, or sublimated means that elevate the intensity of the particles 42. FIG. 9 illustrates another embodiment of the particles 42 in the fluid which comprises a buoyant means 44, which permit the particles 42 to float and be suspended randomly in the fluid.

In an embodiment illustrated in FIG. 5, the fluid itself has means to change its color 46 as affected by ambient temperature change and is well known in the art. FIG. 10 shows a chemical means 48 that creates a reaction when at least two chemicals are combined to produce a dynamic anomaly in the clarity of the filter. Another method for varying the image is accomplished by using two discrete fluids 50 that are not miscible with each other to create dissimilar images, as depicted in FIG. 11.

The invention is basically illustrated having an open top which permits the fluid to be changed easily, however if the lens filter is to be transported, or to allow a camera to be tilted up or down, a removable top 52 may be utilized. This top 52 is disposed within the chamber 36 between the top of the front plate 24 and back plate 26, thereby retaining the fluid 38 contained within in a leak-proof manner. The top 52, which is pictorially illustrated in the exploded view of FIG. 13, simply has a tight fit to accomplish the seal. Other seals and configurations of the top 52 may be used with equal ease in the invention. The fluid 38 may remain permanently in the lens filter therefore the top portion is sealed to the front and back plate after the chamber 36 is filled as shown in FIG. 12, or the seal may be circumferential, as shown in FIG. 16.

It is possible to create another contrasted image by adding a light source 54 that provides a beam of light on one or more of the lateral surfaces. The light 54 may be any suitable type such as a battery powered lamp or an incandescent light powered by a utility power source. The light may be directed to the surface of the front and back plate top, the bottom edge 28, one side edge 30, as shown in FIG. 15, both side edges 30, both front and back plate top and bottom or combined on the front and back plate top, bottom and side edges. The light source 54 can dramatically change the reflection on the particles 42, particularly if they are in the form of glitter.

It should be noted that the invention, in the preferred embodiment, is configured to be adaptable to a video camera 18 as illustrated in FIG. 1. In this case, a lens filter holder 32 is required when used with a matte box 56 as shown, however the filter holder 32, as generically pictured in FIG. 2, requires modification in width to accommodate a wider lens filter 20 as previously described in detail, and the matte box 56 must be altered slightly to accept the wider filter holder 32. In other embodiments of the invention for other cameras 18 similar modifications may be necessary, as the invention must be slightly wider than a ordinary lens filter in order to add the fluid 38 between the plates 24 and 26.

To use the invention, the same procedures are used as with a conventional lens filter, however if a fluid is to be substituted during a photographic session containers and mixing facilities must be provided and a specially-shaped funnel may be utilized along with a device to evenly introduce particles into the filter 20.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. A fluid-containing lens filter for modifying images in photographic, video and motion picture cameras comprising,
a) a filter housing having a front plate, a back plate with a bottom edge and a pair of opposed side edges juxtaposed between the front plate and back plate, said filter housing having a void remaining between the front plate and the back plate, wherein said bottom edge and said side edges are bonded to the front and back plates to form a fluid tight chamber within the filter housing, and
b) a fluid having light modifying qualities disposed within said chamber such that color, translucency and clarity are altered to create a supplementary visual effect on an image viewed by the camera.

2. The fluid-containing lens filter as recited in claim 1 wherein said front plate, back plate, side edges and bottom edge are formed of glass.

3. The fluid-containing lens filter as recited in claim 1 wherein said front plate, back plate, side edges and bottom edge are formed of optically clear thermoplastic.

4. The fluid-containing lens filter as recited in claim 1 wherein said front plate and said back plate of said filter housing have a square shape.

5. The fluid-containing lens filter as recited in claim 4 wherein said filter housing front plate and back plate further comprising an overall dimension of 6.6 by 6.6 inches square (16.8 by 16.8 cm) and 0.5 inches (1.27 cm) deep, wherein the square size used by a conventional cinematographers in most industry standard systems.

6. The fluid-containing lens filter as recited in claim 1 wherein said filter housing side edges and bottom edge further comprise a square configuration.

7. The fluid-containing lens filter as recited in claim 1 wherein said front and back plates further comprise a relationship that is wider on one side of the filter than the other permitting denser filtration at one side of a filter to attenuate the image viewed by the camera.

8. The fluid-containing lens filter as recited in claim 1 wherein said wherein said filter housing bottom edge and said filter housing side edges are bonded to the front plate and back plate selected from the group consisting of adhesive, ultrasonic welding, heat welding which includes elevating the temperature of the edges of the plates to form a homogeneous mass, and chemically melting the side and bottom edges to the plates into a common mass, when solidified.

9. The fluid-containing lens filter as recited in claim 1 wherein said fluid further comprises a color pigment in suspension.

10. The fluid-containing lens filter as recited in claim 1 wherein said fluid further includes a plurality of particles within the fluid having sufficient viscosity to suspend the particles therein.

11. The fluid-containing lens filter as recited in claim 11 wherein said fluid particles further comprise a glitter means that reflect light.

12. The fluid-containing lens filter as recited in claim 11 wherein said fluid particles further comprise a sublimated means which alters the image viewed by the camera.

13. The fluid-containing lens filter as recited in claim 11 wherein said fluid particles further comprise a buoyant means which permits the particles to float and to be randomly suspended in the fluid.

14. The fluid-containing lens filter as recited in claim 1 wherein said fluid further comprises means to change its color.

15. The fluid-containing lens filter as recited in claim 1 wherein said fluid further comprises chemical means for creating a reaction when at least two chemicals are combined to create a dynamic anomaly in the clarity of the filter.

16. The fluid-containing lens filter as recited in claim 1 wherein said fluid further comprises two discrete fluids that are not miscible with each other to create dissimilar images.

17. The fluid-containing lens filter as recited in claim 1 further comprising a top which is sealed to said front plate and back plate after said chamber is filled with said fluid.

18. The fluid-containing lens filter as recited in claim 1 further comprising a removable top disposed within said chamber between a top of said front plate and back plate to retain the fluid within in a leak-proof manner.

19. The fluid-containing lens filter as recited in claim 1 further comprising a light source that provides a beam of light on a surface selected from the group consisting of said front and back plate top, bottom edge, one side edge, both side edges, both front and back plate top and bottom and combined on said front and back plate top, bottom and side edges.
